(19) United States
(12) Patent Application Publication
(10) Pub. No.: US 2024/0396063 A1
(43) Pub. Date: Nov. 28, 2024

(54) FUEL CELL SYSTEM WITH AUTOMATIC DETECTION OF AN EMPTIED WATER SEPARATOR

(71) Applicant: Robert Bosch GmbH, Stuttgart (DE)

(72) Inventors: Timo Bosch, Renningen (DE); Tobias Falkenau, Esslingen (DE)

(21) Appl. No.: 18/689,675

(22) PCT Filed: Sep. 7, 2022
(86) PCT No.: PCT/EP2022/074801

§ 371 Date: Mar. 6, 2024

(30) Foreign Application Priority Data
Sep. 15, 2021 (DE) 10 2021 210 194.1

(51) Int. Cl. H01M 8/04119; H01M 8/04089; H01M 8/04537

(52) U.S. Cl. CPC H01M 8/04164; H01M 8/04097; H01M 8/04626

(57) ABSTRACT

The invention relates to a fuel cell system having at least one fuel cell with an anode, a cathode, a hydrogen supply line, a jet pump which is coupled to the hydrogen supply line, an anode exhaust gas line, a water separator, a discharge valve, a gas conveyor unit which is coupled to the anode exhaust gas line and the jet pump, and a control unit. The water separator is coupled to the anode exhaust gas line and is designed to separate and collect water from an anode exhaust gas, wherein the discharge valve is coupled to the water separator and is designed to discharge separated water from the water separator, and the gas conveyor unit is designed to recirculate anode exhaust gas to the hydrogen supply line via the jet pump. According to the invention, the control unit is coupled to the gas conveyor unit and is designed to at least temporarily detect a power consumption of the gas conveyor unit when the discharge valve is opened, generate a control signal in the event of a drop in the power consumption by a specifiable percentage, and provide same at a control signal output, said control signal representing an emptied water separator.

### BACKGROUND

The present invention relates to a fuel cell system.

Fuel cells use reaction gases in the form of hydrogen and oxygen to generate electrical power by means of catalytic combination, releasing waste heat and water. Air can be used instead of pure oxygen, especially when used in vehicles. The reaction gases must be fed continuously to the fuel cells, with hydrogen being fed to the fuel cells on the anode side and oxygen on the cathode side. Depending on the design, anodes and cathodes can be separated from each other by a membrane. Multiple fuel cells can be combined in the form of a stack with common supply and discharge channels in order to increase the generated electrical voltage and optimize the operation of the fuel cells.

In the fuel cell process, the hydrogen supplied on the anode side is at least partially consumed, whereby water is produced on the cathode side, which also diffuses through to the anode. Water separators are conventionally used to separate liquid water and a gaseous part of the anode exhaust gas. In addition to the separation function, these separators often also store separated water. When the water separator's storage tank is full, the accumulated water is discharged by opening a drain valve, also known as a drain valve.

Nitrogen can enter the anode through diffusion processes. Another source of nitrogen can also be hydrogen that is not completely pure. The presence of nitrogen in the anode can reduce the cell voltage and thus the stack voltage supplied by the fuel cell stack, which leads to efficiency losses. To avoid this, gas is repeatedly discharged from the anode chamber during operation to reduce the nitrogen content there. This discharge takes place using a flushing valve, also known as a purge valve.

According to the prior art, the fuel cells are supplied with hydrogen by means of hydrogen metering valves, which can be designed as proportional valves. One possible control strategy is to use such a valve to regulate the gas pressure within an anode path, measured by a pressure sensor at a defined position, to a defined target pressure depending on the system operating point. Fresh hydrogen is always supplied at the desired target pressure due to consumption of the hydrogen as a result of electrochemical conversion or other losses, for example by opening the discharge valve for too long or by opening the flushing valve. Even the discharge of water leads to a reduction of the water column in the water separator by opening the discharge valve and requires an increased fresh gas flow through the hydrogen dosing valve in order to maintain the desired target pressure.

According to the prior art, depleted anode exhaust gas, which still contains usable hydrogen, is recirculated to a hydrogen inlet. This is often achieved using a combination of a jet pump and an active gas conveyor unit. The jet pump uses the pressure of the supplied fresh hydrogen to recirculate gas in what is referred to as the anode path. The active gas conveyor unit supports this recirculation process.

### SUMMARY

It is desirable to improve the operation of a fuel cell system so that there is no significant loss of performance when the discharge or flushing valve is opened. The object of the invention is therefore to propose a device or a method with which a state of a water separator can be reliably detected in which no more liquid water passes through the discharge valve during a discharging process and a previously formed water column is reduced to a minimum.

Said object is achieved by means of a fuel cell system. Advantageous embodiments and further developments can be gathered the dependent claims and the following description.

Proposed is a fuel cell system having at least one fuel cell with an anode, a cathode, a hydrogen supply line, a jet pump which is coupled to the hydrogen supply line, an anode exhaust gas line, a water separator, a discharge valve, a gas conveyor unit which is coupled to the anode exhaust gas line and the jet pump, and a control unit. The water separator is coupled to the anode exhaust gas line and is designed to separate and collect water from an anode exhaust gas, whereby the discharge valve is coupled to the water separator and is designed to discharge separated water from the water separator, and the gas conveyor unit is designed to recirculate anode exhaust gas to the hydrogen supply line via the jet pump. It is provided that the control unit is coupled to the gas conveyor unit and is designed to at least temporarily detect a power consumption of the gas conveyor unit when the discharge valve is opened, generate a control signal in the event of a drop in the power consumption by a specifiable percentage, and provide same at a control signal output, said control signal representing an emptied water separator.

The fuel cell system preferably comprises multiple fuel cells that are combined to form a fuel cell stack. When used in motor vehicles or commercial vehicles, it is particularly advantageous to use polymer electrolyte membrane (PEM) fuel cells in which the anode is separated from the cathode by a membrane. Alternatively, other forms of fuel cells could of course also be implemented, which can comprise, among other things, solid oxide and direct methanol fuel cells.

In addition to the components specified hereinabove that are arranged on the anode side, components arranged on the cathode side are also necessary, but are not particularly relevant to the object of the invention. For example, the fuel cells can be coupled on the cathode side with an air supply unit, which could have one or more compressors that feed pressurized air into a cathode path upstream of the fuel cell system. The compressor(s) could be driven by an electric motor supplied with a voltage provided by the fuel cell system itself and/or an external voltage source, e.g. a backup battery. In addition, a turbine could also be provided, which is arranged downstream of the fuel cells in the cathode path and supports the compressor(s).

The hydrogen supply line supplies hydrogen to the fuel cell system and can therefore be connected to a hydrogen source. The jet pump, which mixes anode exhaust gas into the hydrogen supply line, is provided downstream of the hydrogen source. The anode exhaust gas, which may still contain a percentage of unused hydrogen, is thus fed back into the anode path and is not lost for utilization in the fuel cell.

The jet pump could comprise a motive nozzle for introducing the hydrogen into a mixing chamber to produce a mixture of fresh hydrogen and recirculated anode exhaust gas. The type of jet pump is irrelevant to the invention. By way of example, reference is made to DE102016210020A1, in which jet pumps are explained. The gas conveyor unit, which can also be referred to as a recirculation blower, is provided to support the jet pump. This unit could be switched on during the flushing process or when the jet pump is likely to deliver insufficient power.

As indicated hereinabove, the anode exhaust gas line carries anode exhaust gas away from the fuel cell system. This is where the water separator is provided, which removes water from the anode exhaust gas. According to the invention, the state of the water separator can be detected in which the water separator is practically completely empty or the water column formed therein is reduced to a minimum. This is achieved by detecting and analyzing the power consumption of the gas conveyor unit.

The power consumption for a defined system operating point depends on whether gas leaves an anode path. If, for example, the discharge valve is opened and gas from the anode exhaust gas line escapes through the discharge valve, the function of the jet pump is supported. As a result, the gas conveyor unit intended to support the jet pump has to provide less mechanical power for this operating state, which means that its power consumption also decreases rapidly. If the fuel cell system is in stationary operation and the water separator is emptied by opening the discharge valve with water flowing out, only a small counter-regulation is required to maintain the target pressure in the anode in order to bring the anode gas volume increased by the water volume to the desired target pressure. If all the water is drained from the water separator after a certain time and the discharge valve is not yet closed, gas can escape from the anode exhaust gas line through the water separator and the discharge valve. As a result, more hydrogen must be supplied in order to maintain the target pressure in the anode. Consequently, the jet pump provides a higher output, which is not used by the gaseous unit.

By detecting the power consumption, a drop in the power consumption by the specifiable percentage can be precisely detected. If this is detected, it is an indication that the water separator has been completely emptied. The difference in performance that occurs is more pronounced the larger the opening of the discharge valve and consequently the stronger the gas flow from the discharge valve. By providing the control signal, this knowledge can be used to, e.g., close the discharge valve again after the water separator has been emptied. In addition, it can be used to continuously calibrate complex models for determining the amount of water in the water separator.

In detail, the power consumption of the gas conveyor unit after the discharge valve is closed again could be slightly lower than before it was opened. The reason for this could be the changing gas concentration in the anode due to the discharge of gas. The reduction in power consumption could be determined by the amount of water and gas discharged as well as the concentration and temperature at the start of the discharge process.

The specifiable percentage could be at least 10%, preferably at least 25% of the power consumption. As explained hereinabove, the percentage by which the power consumption is reduced can depend on the size of the cross-section of the discharge valve through which the flow passes. In addition, the percentage can also depend on the actuation of the discharge valve. For the majority of fuel cell system applications in motor vehicles, a percentage of approximately 25% can be a realistic value that can be detected easily, reliably and with the exclusion of measurement noise.

Furthermore, the control unit could be designed to actuate the discharge valve to open and/or close and to detect the power consumption after the discharge valve is actuated to open. If the control unit actuates the discharge valve to open, the control unit can have direct knowledge of when the discharge valve is opened and consequently start detect the power consumption at this time or directly before it. It is also advantageous to have the control unit close the discharge valve, because the control unit has direct knowledge of the desired, emptied state of the water separator due to the detection of this state as described above and can therefore also use this directly to close the discharge valve.

The control unit could be designed to close the discharge valve by transmitting the control signal. The detection of the emptied state of the water separator is therefore implemented directly to end the discharge of the water separator.

Furthermore, a hydrogen source could be coupled to the hydrogen supply line by means of a hydrogen valve, whereby the hydrogen valve is actuated to reach and/or maintain a target pressure of hydrogen in the anode. The inlet pressure can therefore be regulated by actuating the hydrogen valve accordingly. For this purpose, it can be advantageous to detect a pressure and optionally a temperature of the hydrogen gas flowing in the hydrogen supply line and to take this into account when actuating the hydrogen valve. A corresponding sensor could be provided downstream of the jet pump in particular.

The hydrogen valve could be arranged upstream of the jet pump. It is particularly preferable if the hydrogen valve is arranged upstream of a mixing chamber that is coupled to the jet pump. The hydrogen valve is therefore an independent device for regulating the pressure.

The water separator could also be arranged upstream of the gas conveyor unit. The gas conveyor unit is arranged downstream of the water separator and is only supplied with anode exhaust gas that has been largely freed of water.

The invention further relates to a method for operating a fuel cell system, said method comprising supplying hydrogen to an anode of at least one fuel cell via a hydrogen supply line, recirculating anode exhaust gas from an anode exhaust gas line and into the hydrogen supply line via a jet pump coupled to the hydrogen supply line and a gas conveyor unit coupled to the anode exhaust gas line and the jet pump, separating and collecting water from the anode exhaust gas by means of a water separator coupled to the anode exhaust gas line, and at least temporarily discharging water from the water separator. Provided according to the invention, the detection of a power consumption of the gas conveyor unit when the discharge valve is opened by a control unit coupled to the gas conveyor unit, and the generation of a control signal and provision at a control signal output when the power consumption drops by a specifiable percentage, the control signal representing an emptied water separator.

As explained hereinabove, the specifiable percentage could be at least 25% of the power consumption.

Finally, the method can comprise closing the discharge valve by transmitting the control signal through the control unit.

### BRIEF DESCRIPTION OF THE DRAWINGS

Further measures for improving the invention are described in more detail hereinafter on the basis of the drawings, together with the description of the preferred exemplary embodiments of the invention.

### EXEMPLARY EMBODIMENTS

### Shown are:

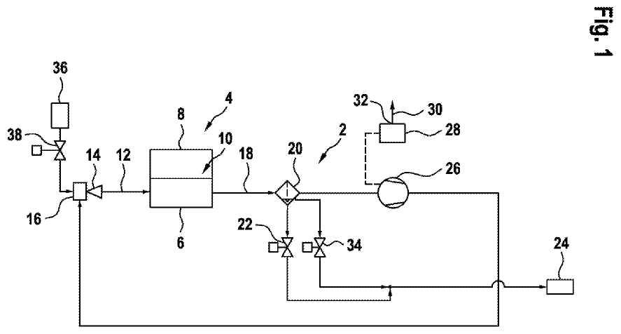

FIG. 1 a schematic representation of the fuel cell system;

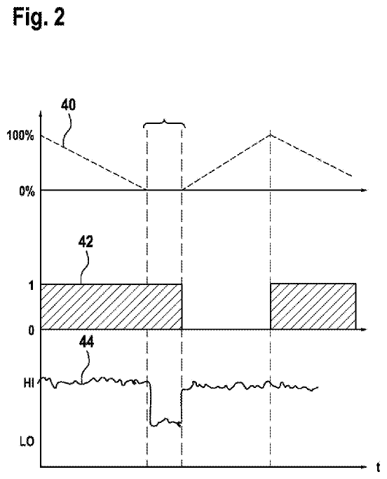

FIG. 2 a diagram showing the filling level, the opening state of the discharge valve and the power consumption of the gas conveyor unit; and

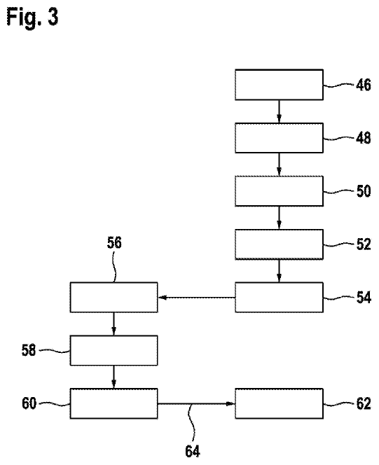

FIG. 3 a block-based representation of a method for operating a fuel cell system.

### DETAILED DESCRIPTION

FIG. 1 shows part of a fuel cell system 2 with a fuel cell 4 with an anode 6, a cathode 8 and a membrane 10 between them. The anode 6 is connected to a hydrogen supply line 12, via which the anode 6 is supplied with hydrogen. A jet pump 14 is coupled to the hydrogen supply line 12 which is, e.g., arranged upstream of a mixing chamber 16.

The anode 6 is further connected to an anode exhaust gas line 18, to which a water separator 20 is coupled. The water separator 20 can separate and collect water from anode exhaust gas. A discharge valve 22 is coupled to the water separator 20 in order to discharge water collected therein and feed it to an outlet 24. A gas conveyor unit 26 is coupled to the anode exhaust gas line 18 and the jet pump 14 and supports the jet pump 14 in recirculating the anode exhaust gas.

A control unit 28 is coupled to the gas conveyor unit 26 and is designed to detect a power consumption of the gas conveyor unit 26 at least temporarily when the discharge valve 22 is opened and to generate a control signal 30 when the power consumption drops by a specifiable percentage and to provide it at a control signal output 32, the control signal representing an emptied water separator 20. The drop in power consumption could be at least 25%. When such a significant drop in performance is detected, the water separator 20 is in a state in which the collected water has been drained and gas begins to flow out of the water separator 20 through the discharge valve. This state can be precisely detected and used in particular to close the discharge valve 22. The control signal 30 could be transmitted to the discharge valve 22 for this purpose. It is in this case assumed that the gas conveyor unit 26 is an electrically operated gas conveyor unit 26 whose power consumption can be easily detected.

Further provided is, e.g., a flushing valve 34, which is intended to flush the anode 6 in order to remove nitrogen. The flushing valve 34 is also connected to the outlet 24.

To supply the hydrogen supply line 12 with fresh hydrogen, a hydrogen source 36 is provided upstream of the jet pump 14, which is coupled to the hydrogen supply line 12 via the mixing chamber 16 by means of a hydrogen valve 38. The hydrogen valve 38 is actuated to reach and/or maintain a target pressure of hydrogen in the anode 6.

FIG. 2 shows an example of a diagram in which a filling level 40 of the water separator 20, an opening state 42 of the discharge valve 22 and a power consumption 44 of the gas conveyor unit 26 are shown one above the other in a chronological sequence. At the beginning, the filling level 40 of the water separator 20 is, e.g., 100%. The discharge valve 22 is opened, and the opening status is in this case “1”. As a result, the filling level 40 decreases continuously. The power consumption 44 of the gas conveyor unit 26 is “HI” in this case, which corresponds to a higher power consumption. After reaching a filling level 40 of approximately 0%, the power consumption 44 drops abruptly to a lower level of “LO”. The filling level 40 remains at 0% while the discharge valve 22 is still opened. This state can be detected by the control unit 28 and used to close the discharge valve 22. If the latter is performed, then the opening state 42 of the discharge valve 22 changes to “0”, after which the filling level 40 begins to rise continuously and the power consumption 44 returns to the previous level “HI”. The drop from “HI” to “LO” can, e.g., be approximately 50%.

FIG. 3 further shows a schematic representation of the method for operating the fuel cell system 2 explained hereinabove and shows the steps of supplying 46 hydrogen to the anode 6 via the hydrogen supply line 12, the recirculation 48 of anode exhaust gas from the anode exhaust gas line 18 and into the hydrogen supply line 12 via the jet pump 14 coupled to the hydrogen supply line 12 and the gas conveyor unit 26 coupled to the anode exhaust gas line 18 and the jet pump 14, the separation 50 and collection 52 of water from the anode exhaust gas by means of the water separator 20 coupled to the anode exhaust gas line 18, and at least temporarily the discharging 54 of water from the water separator 20. According to the invention, the method further comprises detecting 56 the power consumption 44 of the gas conveyor unit 26 when the discharge valve 22 is opened by the control unit 28 coupled to the gas conveyor unit 26 and, when the power consumption 44 drops by a specifiable percentage, generating 58 the control signal 30 and providing 60 at the control signal output 32, whereby the control signal 30 represents an emptied water separator 20. The method further comprises, by way of example, closing 62 the discharge valve 22 by transmitting 64 the control signal 30 via the control unit 28.

1. A fuel cell system (2) having:
at least one fuel cell (4) with an anode (6), a cathode,
a hydrogen supply line (12),
a jet pump (14) which is coupled to the hydrogen supply line (12),
an anode exhaust gas line (18),
a water separator (20),
a discharge valve (22),
a gas conveyor unit (26) which is coupled to the anode exhaust gas line (18) and the jet pump (14), and
a control unit (28),
wherein the water separator (20) is coupled to the anode exhaust gas line (18) and is configured to separate and collect water from an anode exhaust gas,
wherein the discharge valve (22) is coupled to the water separator (20) and is configured to discharge separated water from the water separator (20),
wherein the gas conveyor unit (26) is configured to recirculate anode exhaust gas to the hydrogen supply line (12) via the jet pump (14),
wherein
the control unit (28) is coupled to the gas conveyor unit (26), and
the control unit (28) is configured to detect a power consumption (44) by the gas conveyor unit (26) when the discharge valve (22) is open, generate a control signal (30) in the event of a drop in the power consumption (44) by a specifiable percentage, and provide same at a control signal output (32), wherein the control signal (30) represents an emptied water separator (20).

2. The fuel cell system (2) according to claim 1,
wherein the specifiable percentage is at least 10%, of the power consumption (44).

3. The fuel cell system (2) according to claim 1,
wherein the control unit (28) is configured to actuate the discharge valve (22) to open and/or close, and to detect the power consumption (44) after the discharge valve (22) is actuated to open.

4. The fuel cell system (2) according to claim 3,
wherein the control unit (28) is configured to close the discharge valve (22) by transmitting the control signal (30).

5. The fuel cell system (2) according to claim 1,
wherein a hydrogen source (36) is coupled to the hydrogen supply line (12) via a hydrogen valve (38), wherein the hydrogen valve (38) is actuated to reach and/or maintain a target pressure of hydrogen in the anode (6).

6. The fuel cell system (2) according to claim 5,
wherein the hydrogen valve (38) is arranged upstream of the jet pump (14).

7. The fuel cell system (2) according to claim 1,
wherein the water separator (20) is arranged upstream of the gas conveyor unit (26).

8. A method for operating a fuel-cell system (2), said method comprising:
supplying (46) hydrogen to an anode (6) of at least one fuel cell (4) via a hydrogen supply line (12),
recirculating (48) anode exhaust gas from an anode exhaust gas line (18) and into the hydrogen supply line (12) via a jet pump (14) coupled to the hydrogen supply line (12) and a gas conveyor unit (26) coupled to the anode exhaust gas line (18) and the jet pump (14),
separating (50) and collecting (52) water from the anode exhaust gas by means of a water separator (20) coupled to the anode exhaust gas line (18), and
at least temporarily discharging (54) water from the water separator (20),
wherein
detecting (56) a power consumption (44) of the gas conveyor unit (26) when the discharge valve (20) is opened by a control unit (28) coupled to the gas conveyor unit (26),
generating (58) a control signal and providing (60) at a control signal output (32) when the power consumption (44) drops by a specifiable percentage, wherein the control signal (30) represents an emptied water separator (20).

9. The method according to claim 8,
wherein the specifiable percentage is at least 25% of the power consumption (44).

10. The method according to claim 8,
wherein closing (62) the discharge valve (22) by transmitting (64) the control signal (30) via the control unit (28).
